(19) United States
(12) Patent Application Publication
(10) Pub. No.: US 2003/0079232 A1
(43) Pub. Date: Apr. 24, 2003

(54) Transmission device, reception device, repeating device, frequency list transmitting device, transmission system, and transmission/reception system

(76) Inventors: Hideki Kirino, Kagawa (JP); Kunio Ninomiya, Ehime (JP); Seiji Fujiwara, Ehime (JP)

Correspondence Address: WALL MARJAMA & BILINSKI, 101 SOUTH SALINA STREET, SUITE 400, SYRACUSE, NY, 13202, US

(21) Appl. No.: 10/089,242

(22) PCT Filed: Feb. 20, 2001
(86) PCT No.: PCT/JP01/01202

(30) Foreign Application Priority Data
Jul. 31, 2000 (JP) 2000-230403

(51) Int. Cl. H04N 7/18; H04N 7/173; H04N 7/04

(52) U.S. Cl. 725/124; 725/125; 725/81; 348/470

(57) ABSTRACT

At transmission of a digital modulated wave between a digital set top box and a digital TV, favorable transmission with little picture quality deterioration and noise is realized without employing a coaxial cable.

A list of frequencies which are judged to be unlikely to cause mutually detrimental disturbance between themselves and the other users who are allowed to use a TV broadcast frequency spectrum by a public institution is distributed from a broadcasting station (103) to a digital modulated wave transmission device (101), and the digital modulated wave transmission device (101) transmits a digital modulated wave to a digital modulated wave reception device (102) through an electric lamp wire (129) on the basis of the frequency list (122).

### TECHNICAL FIELD

The present invention relates to a transmission device, a reception device, a repeater, a transmission system, and a transmission reception system, which transmit or receive digital modulated waves, or a frequency list sending device which sends a frequency list.

### BACKGROUND ART

Conventionally, a digital video camcorder and a hard disk recorder (hereinafter, referred to as a “digital set top box”) which can receive and record a digital modulated wave, or a digital TV which can receive the digital modulated wave has been realized.

FIG. 5 is a block diagram illustrating the constitutions of the digital set top box and the digital TV.

In FIG. 5, a digital set top box 501 comprises a digital modulated wave receiver 514 which is connected to a receiving antenna 508, a digital modulated wave transmitter 515 which outputs a digital modulated wave to a digital TV 502, a hard disk recorder 516, a main control unit 517, and a power circuit 518 which is connected to an electric lamp wire socket 512.

On the other hand, the digital TV 502 comprises a power circuit 519 which is connected to an electric lamp wire socket 513, a digital modulated wave receiver 520 which is connected with the digital modulated wave transmitter 515 by a coaxial cable 509 and receives a digital modulated wave, a speaker drive circuit 521, a speaker 522, a main control unit 523, a display drive circuit 524, and a display 525.

The digital set top box 501 and the digital TV 502 are supplied with power by the electric lamp wire 510.

A digital TV broadcasting station 504 has a program contents transmission device 505 which transmits program contents from a broadcasting antenna 503 that is connected with the broadcasting station 504 by a transmission cable 507.

In the so-constituted digital set top box 501, a digital TV broadcasting airwave 506 transmitted from the digital TV broadcasting station 504 is received by the digital modulated wave receiver 514 through the receiving antenna 508, and the received digital modulated wave is recorded/reproduced in the hard disk recorder 516 as well as transmitted to the digital TV 502 by employing the digital modulated wave transmitter 515.

The transmitted digital modulated wave is sent to the digital TV 502 through the coaxial cable 509, received by the digital modulated wave receiver 520, and transmitted through the display drive circuit 524 to the display 525, where video is projected, as well as transmitted through the speaker drive circuit 521 to the speaker 522, where sound is outputted, via the main control unit 523. Thus, the transmission path of the digital modulated wave between the conventional digital set top box 501 and digital TV 502 is shown in a dotted line 511.

As described above, since a radio frequency (RF) signal is outputted from the set top box such as a VCR to the TV receiver through the coaxial cable with no need to provide a special interface in the TV reception device, this method is regularly used.

Meanwhile, to reduce wiring between video devices, so that the devices are easily installed or changed in positions, it is considered that the RF output from the set top box to the TV receiver is performed through the electric lamp wire or through the air via radio waves. Particularly, when an RF signal in a TV broadcasting band is employed for the RF output, there is no need to provide a special RF signal receiver in the TV receiver as described above, thereby realizing RF signal transmission through the electric lamp wire or through the air via radio waves with the minimum cost increase.

However, when the RF signal in the TV broadcasting band is intentionally outputted to the electric lamp wire or emitted in the air via radio waves, there is the possibility that a disturbing radio wave to TV broadcast is generated and other users are subjected to jamming.

Further, it is indispensable to overcome restrictions from Japan's Radio Law prescribing “when jamming is caused due to an RF signal outputted to an electric lamp wire or emitted in the air via radio waves, the output or emission of the RF signal must be stopped”, or rules of the FCC (Federal Communications Commission) of the United States.

The present invention is made to solve the above-mentioned problems and has for its object to provide a transmission device, a reception device, a transmission system, and a transmission reception system, which can realize good transmission of a digital modulated wave with little picture quality deterioration and noise, generate no detrimental disturbing radio wave due to the transmission of the digital modulated wave, can promptly stop generation of the disturbing radio wave if the disturbing radio wave is generated, realize the transmission with a few additional parts, and are easily operated.

Further, the present invention has for its object to provide a repeater which can extend a transmission distance of the digital modulated wave.

Further, the present invention has for its object to provide a frequency list sending device employed in the transmission device, the transmission system, and the transmission reception system, which sends a list of frequencies that are judged to be unlikely to cause mutually detrimental disturbance between themselves and the other users who are allowed to use a TV broadcast frequency spectrum by a public institution.

### DISCLOSURE OF THE INVENTION

According to claim 1 of the present invention, there is provided a transmission system comprising: a transmission device which receives a list of frequencies that are judged to be unlikely to cause mutually detrimental disturbance between themselves and the other users who are allowed to use a TV broadcast frequency spectrum by a public institution, and transmits a digital modulated wave using frequency in the frequency list; and a reception device which receives the digital modulated wave transmitted from the transmission device.

According to the invention, a digital modulated wave is transmitted by using frequency in the list of frequencies that are judged to be unlikely to cause mutually detrimental disturbance between themselves and the other users who are allowed to use a TV broadcast frequency spectrum by a public institution, thereby transmitting the digital modulated wave without generating a disturbing radio wave detrimental to other users nor suffering detrimental transmitting disturbance by strong TV radio wave or the like.

According to claim 2 of the present invention, in the transmission system as defined in claim 1, the transmission device does not transmit the digital modulated wave when the frequency list is not updated within a previously defined period.

According to the invention, a digital modulated wave can be transmitted without generating a disturbing radio wave detrimental to other users nor suffering detrimental transmitting disturbance by strong TV radio wave or the like, and further generation of the detrimental disturbing radio wave can be prevented.

According to claim 3 of the present invention, in the transmission system as defined in claim 1, the transmission device transmits the digital modulated wave through an electric lamp wire, and the reception device receives the digital modulated wave transmitted through the electric lamp wire.

According to the invention, in addition to the same effect as the effect of the invention according to claim 1, a digital modulated wave can be transmitted without using a coaxial cable, whereby the transmission device and the reception device can be easily changed in positions or cleaned.

According to claim 4 of the present invention, in the transmission system as defined in claim 1, the transmission device transmits the digital modulated wave through the air via radio waves, and the reception device receives the digital modulated wave transmitted through the air.

According to the invention, in addition to the same effect as the effect of the invention according to claim 1, a digital modulated wave can be transmitted without using a coaxial cable, whereby the transmission device and the reception device can be easily changed in positions or cleaned.

According to claim 5 of the present invention, in the transmission system as defined in claim 1, the transmission device transmits the digital modulated wave with source information as information on the digital modulated wave added thereto, and the reception device includes a display for projecting video, receives the digital modulated wave to which the source information is added, and projects video on the display on the basis of the source information.

According to the invention, in addition to the same effect as the effect of the invention according to claim 1, information on a digital modulated wave received by the reception device, such as a channel, can be displayed.

According to claim 6 of the present invention, the transmission system as defined in claim 1 includes a plurality of the reception devices.

According to the invention, in addition to the same effect as the effect of the invention according to claim 1, the same video and sound can be received by plural receivers.

According to claim 7 of the present invention, the transmission system as defined in claim 1 further includes a repeater which receives the digital modulated wave transmitted from the transmission-device and transmits the digital modulated wave at frequency included in the frequency list, which is different from the frequency of the received digital modulated wave, and in the transmission system, the reception device receives the digital modulated wave from the repeater, instead of the digital modulated wave from the transmission device.

According to the invention, in addition to the same effect as the effect of the invention according to claim 1, the repeater is provided, thereby extending a transmission distance of a digital modulated wave from the transmission device to the reception device.

According to claim 8 of the present invention, the transmission system as defined in claim 7 includes a plurality of the repeaters.

According to the invention, in addition to the same effect as the effect of the invention according to claim 8, the transmission distance can be further extended.

According to claim 9 of the present invention, in the transmission system as defined in claim 1, the transmission device and the reception device perform transmission and reception of the digital modulated wave in the same building.

According to the invention, a digital modulated wave can be transmitted without generating a disturbing radio wave detrimental to other users nor suffering detrimental transmitting disturbance by strong TV radio wave or the like, and further deterioration in picture quality due to transmission of the digital modulated wave and the like can be reduced.

According to claim 10 of the present invention, there is provided a transmission device which receives a list of frequencies that are judged to be unlikely to cause mutually detrimental disturbance between themselves and the other users who are allowed to use a TV broadcast frequency spectrum by a public institution, and transmits a digital modulated wave using frequency in the frequency list.

According to the invention, a digital modulated wave is transmitted by using frequency in the list of frequencies that are judged to be unlikely to cause mutually detrimental disturbance between themselves and the other users who are allowed to use a TV broadcast frequency spectrum by a public institution, thereby transmitting the digital modulated wave without generating a disturbing radio wave detrimental to other users nor suffering detrimental transmitting disturbance by strong TV radio wave or the like.

According to claim 11 of the present invention, the transmission device as defined in claim 10 comprises: a reception means for receiving a digital modulated wave from a broadcasting station and demodulating the digital modulated wave into a video/sound signal; a transmission means for modulating the video/sound signal into a digital modulated wave and transmitting the digital modulated wave; and a control means for outputting the video/sound signal from the reception means to the transmission means and controlling the transmission means so that it transmits the video/sound signal at the frequency in the frequency list.

According to the invention, in addition to the same effect as the effect of the invention according to claim 10, a few additional parts are added to a conventional transmission device, thereby realizing a relatively low-priced transmission device.

According to claim 12 of the present invention, the transmission device as defined in claim 10 does not transmit the digital modulated wave when the frequency list is not updated within a previously defined period.

According to the invention, a digital modulated wave can be transmitted without generating a disturbing radio wave detrimental to other users nor suffering detrimental transmitting disturbance by strong TV radio wave or the like, and further generation of the detrimental disturbing radio wave can be prevented.

According to claim 13 of the present invention, the transmission device as defined in claim 10 transmits the digital modulated wave through an electric lamp wire.

According to the invention, in addition to the same effect as the effect of the invention according to claim 10, a digital modulated wave can be transmitted without using a coaxial cable.

According to claim 14 of the present invention, the transmission device as defined in claim 10 transmits the digital modulated wave through the air via radio waves.

According to the invention, in addition to the same effect as the effect of the invention according to claim 10, a digital modulated wave can be transmitted without using a coaxial cable.

According to claim 15 of the present invention, the transmission device as defined in claim 10 transmits the digital modulated wave with source information as information on the digital modulated wave added thereto.

According to the invention, in addition to the same effect as the effect of the invention according to claim 10, in the device that has received the digital modulated wave to which the source information is added, information on a digital modulated wave, such as a channel, can be displayed by employing the source information.

According to claim 16 of the present invention, the transmission device as defined in claim 10 creates a second frequency list in which the frequency employed for the transmission of the digital modulated wave is deleted from the frequency list, and transmits the digital modulated wave with the second frequency list added thereto.

According to the invention, in addition to the same effect as the effect of the invention according to claim 10, by employing the second frequency list, the device that has received the digital modulated wave can further transmit a digital modulated wave without generating a disturbing radio wave detrimental to other users nor suffering detrimental transmitting disturbance by strong TV radio wave or the like.

According to claim 17 of the present invention, the transmission device as defined in claim 10 transmits the digital modulated wave to devices in the same building.

According to the invention, in addition to the same effect as the effect of the invention according to claim 10, deterioration in picture quality due to transmission of the digital modulated wave can be reduced.

According to claim 18 of the present invention, there is provided a reception device which receives a digital modulated wave transmitted at frequency that is judged to be unlikely to cause mutually detrimental disturbance between itself and the other users who are allowed to use a TV broadcast frequency spectrum by a public institution.

According to the invention, a digital modulated wave is received by using frequency in the list of frequencies that are judged to be unlikely to cause mutually detrimental disturbance between themselves and the other users who are allowed to use a TV broadcast frequency spectrum by a public institution, thereby receiving the digital modulated wave without generating a disturbing radio wave detrimental to other users nor suffering detrimental transmitting disturbance by strong TV radio wave or the like.

According to claim 19 of the present invention, the reception device as defined in claim 18 receives a digital modulated wave transmitted through an electric lamp wire.

According to the invention, in addition to the same effect as the effect of the invention according to claim 18, a digital modulated wave can be received without using a coaxial cable, whereby the reception device can be easily changed in position or cleaned.

According to claim 20 of the present invention, the reception device as defined in claim 18 receives a digital modulated wave transmitted through the air via radio waves.

According to the invention, in addition to the same effect as the effect of the invention according to claim 18, a digital modulated wave can be received without using a coaxial cable, whereby the reception device can be easily changed in position or cleaned.

According to claim 21 of the present invention, there is provided a reception device comprising: a reception means for receiving a digital modulated wave to which source information as information on the digital modulated wave is added and demodulating the digital modulated wave into a video/sound signal and the source information; a speaker which outputs sound; a display which projects video; and a control means for receiving the video/sound signal and the source information from the reception means, and outputting the sound signal to the speaker, while outputting a signal indicating video on the basis of the source information and the video signal from the reception means to the display.

According to the invention, information on a digital modulated wave received by the reception device, such as a channel, can be displayed.

According to claim 22 of the present invention, there is provided a repeater which receives a digital modulated wave to which a frequency list is added, creates a second frequency list in which frequency used for transmission of the digital modulated wave is deleted from the frequency list, and transmits the digital modulated wave with the second frequency list added thereto.

According to the invention, the repeater is employed, thereby extending a transmission distance of a digital modulated wave from a device which transmits the digital modulate wave to a device which receives the digital modulated wave.

According to claim 23 of the present invention, there is provided a frequency list sending device which sends a list of frequencies that are judged to be unlikely to cause mutually detrimental disturbance between themselves and the other users who are allowed to use a TV broadcast frequency spectrum by a public institution.

According to the invention, it is possible to transmit the list of frequencies which generate no disturbing radio wave detrimental to other users and are not subjected to detrimental transmitting disturbance by strong TV radio wave or the like, which list is employed for transmission of a digital modulated wave.

According to claim 24 of the present invention, there is provided a transmission reception system comprising: a frequency list sending device which sends a list of frequencies that are judged to be unlikely to cause mutually detrimental disturbance between themselves and the other users who are allowed to use a TV broadcast frequency spectrum by a public institution; a transmission device which receives the frequency list and transmits a digital modulated wave using frequency in the frequency list; and a reception device which receives the digital modulated wave transmitted from the transmission device, and in the transmission reception device, the transmission device does not transmit the digital modulated wave when the frequency list is not updated within a previously determined period.

According to the invention, a digital modulated wave is transmitted by using frequency in the list of frequencies that are judged to be unlikely to cause mutually detrimental disturbance between themselves and the other users who are allowed to use a TV broadcast frequency spectrum by a public institution, thereby transmitting the digital modulated wave without generating a disturbing radio wave detrimental to other users nor suffering detrimental transmitting disturbance by strong TV radio wave or the like.

### BRIEF DESCRIPTION OF DRAWINGS

FIG. 1 is a block diagram illustrating the constitutions of a broadcasting station and a transmission system according to a first embodiment of the present invention.

FIG. 2 is a block diagram illustrating the constitutions of a broadcasting station and a transmission system according to a second embodiment of the present invention.

FIG. 3 is a block diagram illustrating the constitutions of a broadcasting station and a transmission system according to a third embodiment of the present invention.

FIG. 4 is a block diagram illustrating the constitutions of a broadcasting station and a transmission system according to a fourth embodiment of the present invention.

FIG. 5 is a block diagram illustrating the constitutions of a conventional digital set top box and digital TV.

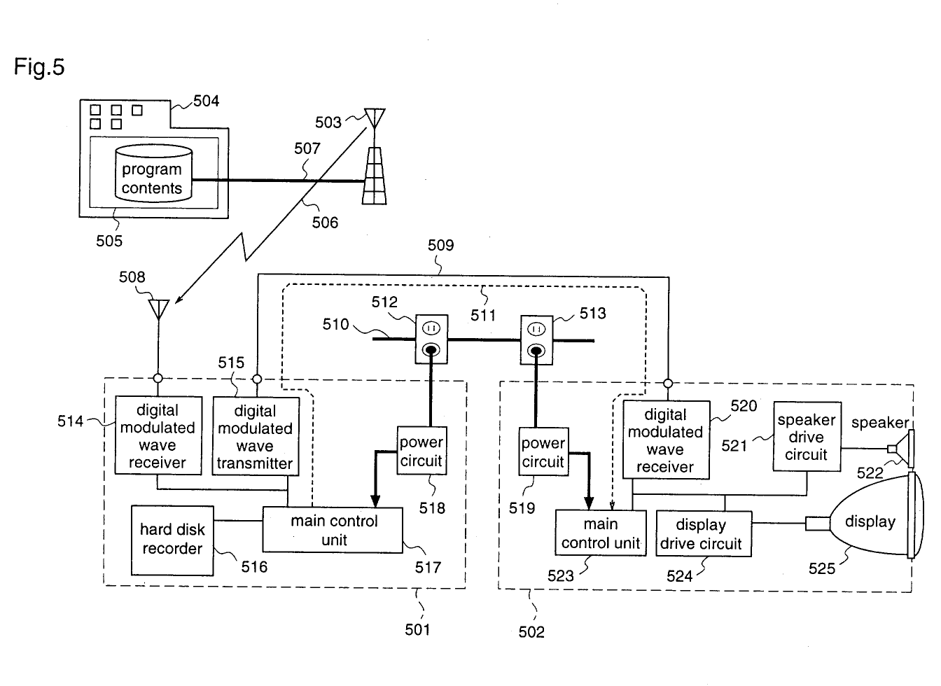

### BEST MODE TO EXECUTE THE INVENTION

(Embodiment 1)

Hereinafter, a transmission system, transmission device, and reception device according to a first embodiment of the present invention will be described with reference to the drawing. The transmission system according to the first embodiment transmits a digital modulated wave through an electric lamp wire.

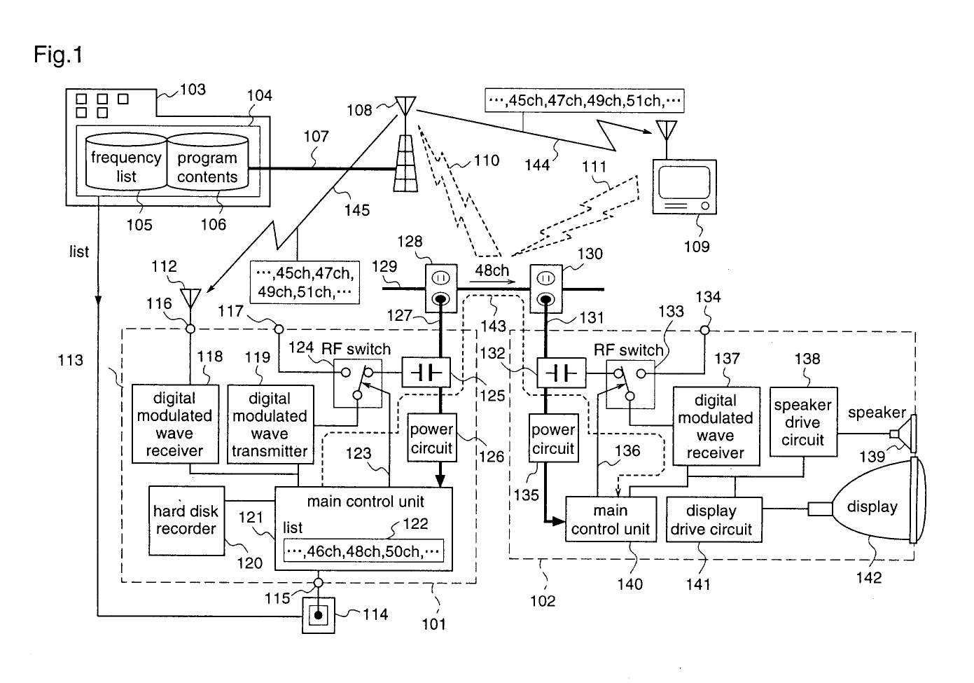

FIG. 1 is a block diagram illustrating the constitutions of a broadcasting station and the transmission system according to the first embodiment.

In FIG. 1, the transmission system according to the first embodiment comprises a digital modulated wave transmission device 101 which receives a frequency list and transmits a digital modulated wave employing frequency in the frequency list, and a digital modulated wave reception device 102 which receives the digital modulated wave transmitted from the digital modulated wave transmission device 101. Here, as the digital modulated wave transmission device 101, there is for example the above-described digital set top box. As the digital modulated wave reception device 102, there is for example the above-described digital TV.

The digital modulated wave transmission device 101 comprises a telephone line terminal 115 which is connected to a telephone jack 114; an RF input terminal 116 which is connected to a receiving antenna 112; an RF output terminal 117; a digital modulated wave receiver 118; a digital modulated wave transmitter 119; a hard disk recorder 120; a main control unit 121, an RF switch control line 123; an RF switch 124; a coupling capacitor 125; and a power circuit 126.

The digital modulated wave receiver 118 receives a digital TV broadcasting airwave 145 through the receiving antenna 112 and the RF input terminal 116, and demodulates a digital modulated wave of a specific channel, which is included in the broadcasting airwave 145 according to control by the main control unit 121. Then, a video/sound signal is outputted.

The digital modulated wave transmitter 119 modulates the video/sound signal inputted from the main control unit 121 into a digital modulated wave of a channel specified by the main control unit 121, and outputs the digital modulated wave to the RF switch 124.

The hard disk recorder 120 records the video/sound signal inputted from the main control unit 121 in a hard disk and holds the video/sound signal therein. When there is an instruction from the main control unit 121, a specific recorded video/sound signal is reproduced and outputted to the main control unit 121.

The main control unit 121 performs control over the respective constituent elements of the digital modulated wave transmission device 101, and is realized by a CPU by program control, for example. Further, a frequency list 122 which is transmitted from the broadcasting station 103 through a telephone subscriber line 113 is stored in the main control unit 121. The frequency list 122 is a list of frequencies which are judged to be unlikely to cause mutually detrimental disturbance between themselves and the other users who are allowed to use a TV broadcast frequency spectrum by a public institution.

The RF switch 124 switches between the coupling capacitor 125 and the RF output terminal 117 for the output of the digital modulated wave from the digital modulated wave transmitter 119 according to control by the main control unit 121 through the RF switch control line 123.

The coupling capacitor 125 puts the digital modulated wave from the RF switch 124 on a power line 127. The coupling capacitor 125 is connected to an electric lamp wire socket 128 by the power line 127.

The power circuit 126 supplies power to the main control unit 121.

Further, the digital modulated wave reception device 102 comprises a coupling capacitor 132; an RF switch 133; an RF input terminal 134; a power circuit 135; an RF switch control line 136; a digital modulated wave receiver 137; a speaker drive circuit 138; a speaker 139; a main control unit 140; a display drive circuit 141; and a display 142.

The power circuit 135 and the digital modulated wave receiver 137 are the same as the power circuit 126 and the digital modulated wave receiver 118, respectively.

The coupling capacitor 132 extracts a digital modulated wave flowing through a power line 131. This coupling capacitor 132 is connected to the electric lamp wire socket 130 by the power line 131.

The RF switch 133 switches between the digital modulated wave from the coupling capacitor 132 and the digital modulated wave from the RF input terminal 134 as a digital modulated wave to transmit to the digital demodulated wave receiver 137 according to control by the main control unit 140 through the RF switch control line 136.

The speaker drive circuit 138 receives a sound signal from the main control unit 140 and drives the speaker 139 to output sound therefrom.

The main control unit 140 performs control over the respective constituent elements of the digital modulated wave reception device 102, and is realized by a CPU by program control, for example.

The display drive circuit 141 receives a video signal from the main control unit 140 and drives the display 142 to project video thereon.

The electric lamp wire socket 128 and the electric lamp wire socket 130 are connected to an electric lamp wire 129 and supplied with power therefrom.

The digital TV broadcasting station 103 which performs broadcasting from a digital TV broadcasting antenna 108 through a transmission cable 107 has a frequency list transmission device 104 which transmits a list of frequencies that are judged to be unlikely to cause mutually detrimental disturbance between themselves and the other users who are allowed to use a TV frequency spectrum by a public institution. The frequency list transmission device 104 holds a list 105 of frequencies that are judged to be unlikely to cause mutually detrimental disturbance between themselves and the other users who are allowed to use a TV frequency spectrum by a public institution, and a program contents 106.

Distribution of the frequency list 105 by the frequency list transmission device 104 is performed periodically, for example every day or every month. The period may be variable. For example, it is possible that at the beginning of use of the system according to the present invention in a prescribed area, the frequency list 105 is frequently distributed on a daily basis, and after a certain period of time, the frequency list 105 is distributed every week or every month. Further, the frequency list 105 may be distributed from the broadcasting station 103 to each user unilaterally, or each user side, that is, the digital modulated wave transmission device 101, may download the frequency list 105 from the broadcasting station 103.

Further, it is also possible to transmit the frequency list 105 through the cable Internet or a portable phone. Even when there is no frequency list 105 in the broadcasting station 103, a company which provides services of managing and distributing broadcast programs of each broadcasting station may distribute the frequency list as part of its services.

Further, the digital TV broadcasting station 103 checks broadcasting frequency and transmission power from the neighboring digital TV broadcasting station, so as to specify frequency at which another user 109 receives broadcast, whereby the list of frequencies considered to cause no detrimental disturbance, which list is made by deleting the specified frequency, may be superposed on a broadcasting airwave to be distributed. In that case, the telephone subscriber line 113 is not required.

Next, operations of the transmission system, transmission device, and reception device according to the first embodiment will be described.

The digital TV broadcasting airwaves 144 and 145 are emitted from the digital TV broadcasting antenna 108 of the digital TV broadcasting 103 at the frequencies of . . . 45ch, 47ch, 49ch, 51ch, . . . .

In this broadcasting area, the frequencies corresponding to channels 46ch, 48ch, and 50ch are considered to cause no disturbance (receiving disturbance) detrimental to the above-described frequencies of . . . 45ch, 47ch, 49ch, 51ch, . . . at which the other user 109, who is allowed to use a TV broadcast frequency spectrum by a public institution, receives broadcast.

The frequency list transmission device 104 in the digital TV broadcasting station 103 distributes the list 105 of frequencies corresponding to the channels which are considered to cause no disturbance detrimental to the other user 109, to the main control unit 121 through the telephone subscriber line 113, the telephone jack 114 in household, and the telephone line terminal 115 of the digital modulated wave transmission device 101.

The distributed frequency list is stored in the main control unit 121. In preparation for the case where allocation of the frequency of digital TV broadcasting is changed and thus the frequency list is modified or the case where the frequency list is partially modified due to the reason that another user who uses a highly sensitive receiving antenna in a neighboring broadcasting area suffers detrimental disturbance, the main control unit 121 checks whether the frequency list is updated within a previously defined period or not, and does not transmit a digital modulated wave when updating is not confirmed. Thereby, generation of a detrimental disturbing radio wave 111 can be prevented.

The digital modulated wave receiver 118 selects a digital modulated wave of a prescribed channel indicated by the main control unit 121 from the digital modulated waves received through the receiving antenna 112 and the RF input terminal 116, demodulates the selected digital modulated wave, and outputs a video/sound signal to the main control unit 121. When the frequency list is superposed on the digital modulated wave to be transmitted, the digital modulated wave receiver 118 also outputs the frequency list to the main control unit 121.

The main control unit 121 receives the video/sound signal from the digital modulated wave receiver 118. When the video/sound signal is recorded on the instruction of a user, the video/sound signal is recorded in the hard disk recorder 120. On the other hand, when the video/sound signal is transmitted to the digital modulated wave reception device 102 without being recorded on the instruction of the user, the video/sound signal received from the digital modulated wave receiver 118 is outputted to the digital modulated wave transmitter 119. When there is an instruction from the user that a prescribed video/sound signal recorded in the hard disk recorder 120 is reproduced, the main control unit 121 extracts the video/sound signal from the hard disk recorder 120 and outputs it to the digital modulated wave transmitter 119.

When outputting the video/sound signal to the digital modulated wave transmitter 119, the main control unit 121 selects a channel from the frequencies stored in the frequency list 122 of the main control unit 121, and instructs the digital modulated wave transmitter 119 to transmit the video/sound signal on that channel. In the first embodiment, 48ch is selected.

The digital modulated wave receiver 119 receives the video/sound signal and the instruction to transmit the video/sound signal on 48ch from the main control unit 121, and then it modulates the video/sound signal into a digital modulated wave of 48ch and outputs the digital modulated wave to the RF switch 124.

When the RF switch 124 is connected to the coupling capacitor 125 side as shown in FIG. 1, the digital modulated wave outputted from the digital modulated wave transmitter 119 is transmitted to the electric lamp wire 129 through the coupling capacitor 125, the power line 127, and the electric lamp wire socket 128, and sent to the digital modulated wave reception device 102 through the electric lamp wire socket 130 and the power line 131. In this way, transmission of the digital modulated wave is performed by employing frequency in the frequency list 122, thereby preventing transmitting disturbance due to a detrimental disturbing radio wave 110 by strong TV broadcasting.

The digital modulated wave inputted to the digital modulated wave reception device 102 is received by the digital modulated wave receiver 137 through the coupling capacitor 132 and the RF switch 133.

The main control unit 140 makes the digital modulated wave receiver 137 execute channel search and detect the digital modulated wave inputted to the digital modulated wave receiver 137. Further, at the detection of the digital modulated wave, a prescribed code for discriminating an extraneous radio wave may be added to the digital modulated wave transmitted from the digital modulated wave transmission device 101 in order to discriminate between the digital modulated wave transmitted from the digital modulated wave transmission device 101 to the digital modulated wave reception device 102 and an extraneous radio wave such as the disturbing radio wave 110 by TV broadcasting. In that case, by detecting the code, the digital modulated wave receiver 137 can detect the digital modulated wave from the digital modulate wave transmission device 101.

Then, when detecting the digital modulated wave of 48ch, the digital modulated wave receiver 137 demodulates the digital modulated wave and outputs a video/sound signal to the main control unit 140. Thus, the transmission path of the digital modulated wave according to the first embodiment is shown in a dotted line 143.

Of the video/sound signal received from the digital modulated wave receiver 137, the main control unit 140 outputs a sound signal to the speaker drive circuit 138, while it outputs a video signal to the display drive circuit 141. Then, sound is outputted from the speaker 139 and video is projected on the display 142.

Further, under extremely undesirable environment for transmission through the electric lamp wire 129, the RF switch 124 of the digital modulated wave transmission device 101 is turned to the RF output terminal 117 side, and the RF switch 133 of the digital modulated wave reception device 102 is turned to the RF input terminal 134 side, so that the RF output terminal 117 and the RF input terminal 134 are connected by a coaxial cable, whereby it is also possible to perform transmission of the digital modulated wave employing a backup transmission path.

Further, while in the first embodiment the digital modulated wave transmitted by the digital modulated wave transmission device 101 is received by a single digital modulated wave reception device 102, the digital modulated wave transmitted by the digital modulated wave transmission device 101 may be received by plural digital modulated wave reception devices.

Further, it is also possible that the digital modulated wave reception device has no display and records the video/sound signal in a recording medium such as a DVD-RAM.

As described above, according to the transmission system, transmission device 101, and reception device 102 of the first embodiment, the digital modulated wave is transmitted through the electric lamp wire 129 without using a coaxial cable, whereby a digital set top box and a digital TV are more easily changed in positions or cleaned as compared with a case where those devices are connected by the coaxial cable.

The transmission of the digital modulated wave through the electric lamp wire 129 is performed employing the frequency included in the list of frequencies that are judged to be unlikely to cause mutually detrimental disturbance between themselves and the other users who are allowed to use a TV broadcast airwave spectrum by a public institution, whereby the digital modulated wave can be transmitted without generating the disturbing radio wave 111 detrimental to other users nor suffering detrimental disturbance (transmitting disturbance) by strong TV radio wave, and favorable transmission of the video/sound signal without noise and picture quality deterioration can be realized even with a weak radio wave unless it is under the transmission lower limit, without having an effect detrimental to the other users. Therefore, according to the present invention, as long as there is frequency which corresponds to a channel that is considered to cause no disturbance detrimental to other users, the digital modulated wave can be transmitted without using a coaxial cable.

Further, when the disturbing radio wave 111 is generated to other user 109 by the transmission of the digital modulated wave through the electric lamp wire 129, the broadcasting station 103 deletes the frequency which has generated the disturbing radio wave 111 from the frequency list when updating the frequency list 122, thereby promptly stopping the generation of the disturbing radio wave by the transmission of the digital modulated wave through the electric lamp wire 129.

Further, when the frequency list 122 is not updated, the digital modulated wave transmission device 101 does not transmit the digital modulated wave, thereby preventing the generation of the disturbing radio wave 111.

Moreover, since transmission of the video/sound signal is performed employing an RF signal (digital modulated wave) in a TV broadcasting band, there is no need to provide a special interface in the digital modulated wave reception device 102 and the RF switches 142 and 133 and the coupling capacitors 125 and 132 are added to a conventional construction and only a few additional parts are required, thereby minimizing cost increase and realizing a device best suited for consumers' uses.

Furthermore, when the digital modulated wave is received by the plural digital modulated wave reception devices 102, the same video and sound can be received by the plural reception devices 102, and in a case where the plural reception devices 102 are digital TVs, the same video and sound can be viewed simultaneously by plural users, and in a case where one of the reception devices 102 is a digital TV and the other reception devices 102 are DVD-RAM recorders, the video and sound can be held in the DVD-RAMs while the video and sound are being viewed.

Further, the broadcasting station 103 can accurately recognize use areas of the digital modulated wave transmission device 101 and the digital modulated wave reception device 102 by referring to registered addresses of telephone subscribers, thereby efficiently utilizing the list of frequencies considered to cause no detrimental disturbance.

While in FIG. 1 the digital modulated wave transmission device 101 and the digital modulated wave reception device 102 are connected to the different electric lamp wire sockets respectively, the both devices may be connected to the same electric lamp wire socket. Further, it is preferable that the electric lamp wire sockets to which the both devices are connected are adjacent electric lamp wire sockets in the same building such as a house and an office.

The RF input terminal 116 of the digital modulated wave transmission device 101 may be used to receive a digital modulated wave outputted from a satellite broadcast receiving set top box or a cable TV set top box.

While the digital modulated wave transmission device 101 includes the hard disk recorder 120, the digital modulated wave transmission device 101 may include a recorder which records the video/sound signal in other kinds of recording media than the hard disk.

(Embodiment 2)

Hereinafter, a transmission system, transmission device, and reception device according to a second embodiment of the present invention will be described with reference to the drawing. The transmission system according to the second embodiment transmits a digital modulated wave through the air via radio waves.

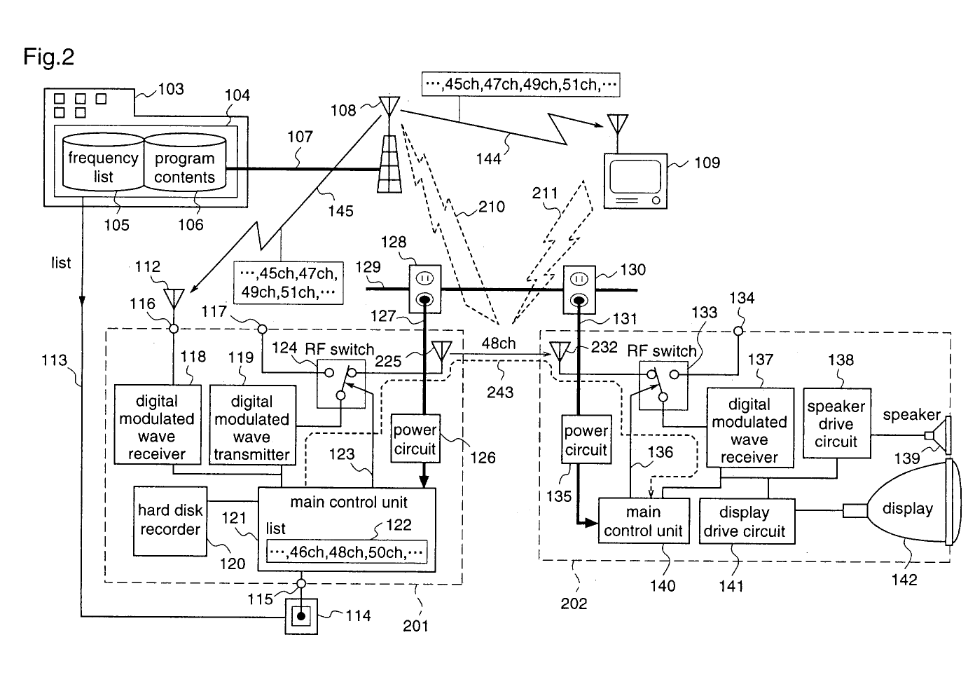

FIG. 2 is a block diagram illustrating the constitutions of a broadcasting station and the transmission system according to the second embodiment.

In FIG. 2, the transmission system according to the second embodiment comprises a digital modulated wave transmission device 201 which receives a frequency list and transmits a digital modulated wave employing frequency in the frequency list, and a digital modulated wave reception device 202 which receives the digital modulated wave transmitted from the digital modulated wave transmission device 201. Here, as the digital modulated wave transmission device 201, there is for example the above-described digital set top box. As the digital modulated wave reception device 202, there is for example the above-described digital TV.

The digital modulated wave transmission device 201 includes a transmitting antenna 225 instead of the coupling capacitor 125 according to the first embodiment. Further, the digital modulated wave reception device 202 includes a receiving antenna 232 instead of the coupling capacitor 132 according to the first embodiment. The same reference numerals as those shown in FIG. 1 denote the same parts of the broadcasting station and transmission system according to the first embodiment, and descriptions thereof will be omitted.

Next, operations of the transmission system, transmission device, and reception device according to the second embodiment will be described. Except for the parts involving the transmitting antenna 225 and the receiving antenna 232, the operation of the transmission system is the same as that in the first embodiment, and descriptions thereof will be omitted.

A digital modulated wave outputted from the digital modulated wave transmitter 119 is transmitted through the RF switch 124 in the air as a radio wave from the transmitting antenna 225. Then, the radio wave is received by the digital modulated wave receiver 137 through the receiving antenna 232 and the RF switch 133. Thus, the transmission path of the digital modulated wave according to the second embodiment is shown in a dotted line 243.

Further, under extremely undesirable environment for transmission through the transmitting antenna 225 and the receiving antenna 232, the RF switch 124 of the digital modulated wave transmission device 201 is turned to the RF output terminal 117 side, and the RF switch 133 of the digital modulated wave reception device 202 is turned to the RF input terminal 134 side, so that the RF output terminal 117 and the RF input terminal 134 are connected by a coaxial cable, whereby it is also possible to perform transmission of the digital modulated wave employing a backup transmission path.

As described above, according to the transmission system, transmission device 201, and reception device 202 of the second embodiment, the digital modulated wave is transmitted as a radio wave from the transmitting antenna 225 to the receiving antenna 232 without using a coaxial cable, thereby achieving the same effect as the effect of the first embodiment.

Further, it is preferable that the digital modulated wave transmission device 201 and the digital modulated wave reception device 202 are used at adjacent positions in the same building such as a house and an office.

(Embodiment 3)

Hereinafter, a transmission system, a transmission device, and a reception device according to a third embodiment of the present invention will be described with reference to the drawing. The transmission system according to the third embodiment comprises the transmission device which transmits a digital modulated wave with its source information added thereto, and the reception device which receives the digital modulated wave to which the source information is added and displays video according to the source information.

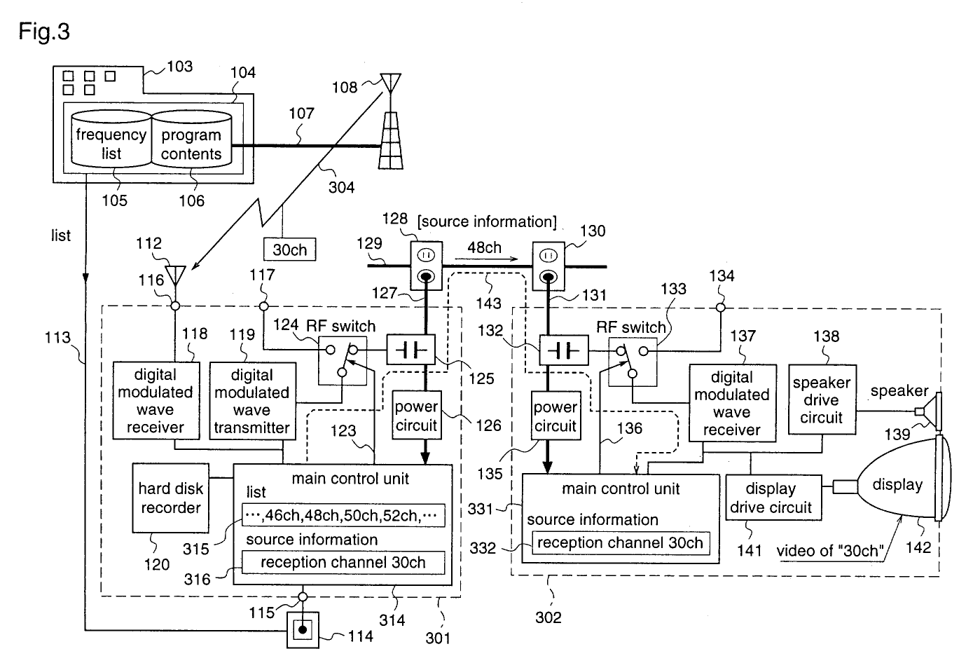

FIG. 3 is a block diagram illustrating the constitutions of a broadcasting station and the transmission system according to the third embodiment.

In FIG. 3, the transmission system according to the third embodiment comprises a digital modulated wave transmission device 301 which receives a frequency list and transmits a digital modulated wave employing frequency in the frequency list, and a digital modulated wave reception device 302 which receives the digital modulated wave transmitted from the digital modulated wave transmission device 301. Here, as the digital modulated wave transmission device 301, there is for example the above-described digital set top box. As the digital modulated wave reception device 302, there is for example the above-described digital TV. The same reference numerals as those shown in FIG. 1 denote the same parts of the broadcasting station and transmission system according to the first embodiment, and descriptions thereof will be omitted.

A main control unit 314 included in the digital modulated wave transmission device 301 has functions of creating source information 316 relating to a channel of a received radio wave and outputting the source information 316, too, in addition to the same function as the function of the main control unit 121 according to the first embodiment.

Further, a main control unit 331 included in the digital modulated wave reception device 302 has functions of storing the source information received from the digital modulated wave transmission device 301 as source information 332 and displaying a display channel on the display 142 on the basis of the source information 332, in addition to the same function as the function of the main control unit 140 according to the first embodiment.

Next, operations of the transmission system, transmission device, and reception device according to the third embodiment will be described. Except for the parts involving the main control units 314 and 331, the operation of the transmission system is the same as that of the transmission system according to the first embodiment, and descriptions thereof will be omitted.

A broadcasting airwave 304 is emitted from the digital TV broadcasting station 103 on 30ch, and the digital modulated wave transmission device 301 receives the airwave through the receiving antenna 112.

The main control unit 314 creates information that the channel on which broadcast is received is 30ch and stores the information in the main control unit 314 as the source information 316. Then, when receiving a video/sound signal from the digital modulated wave receiver 118 and outputting the video/sound signal to the digital modulated wave transmitter 119, the main control unit 314 adds the source information 316 to the video/sound signal and outputs it to the digital modulated wave transmitter 119.

Receiving the video/sound signal and the source information from the main control unit 314, the digital modulated wave transmitter 119 modulates the video/sound signal to which the source information is added into a digital modulated wave of transmission frequency specified by the main control unit 314, such as 48ch, and outputs the digital modulated wave to the RF switch 124.

The path for transmitting the digital modulated wave to the digital modulated wave receiver 137 of the digital modulated wave reception device 302 is the same as that described in the first embodiment.

When the digital modulated wave receiver 137 receives the digital modulated wave, the digital modulated wave receiver 137 demodulates the digital modulated wave and outputs the video/sound signal to which the source information is added to the main control unit 331.

The main control unit 331 receives the video/sound signal to which the source information is added, separates the source information, and stores it. Then, the main control unit 331 controls the speaker drive circuit 138 and the display drive circuit 141 so that sound is outputted from the speaker 139 and video is projected on the display 142, like the main control unit 140 according to the first embodiment.

Further, the main control unit 331 creates an OSD (On Screen Display) signal on the basis of the source information 332, outputs the OSD signal to the display drive circuit 141, and displays a channel on the display 142 on the basis of the source information 332. In this case, the character of “30ch” is displayed on the display 142.

When video recorded in the hard disk recorder 120 of the digital modulated wave transmission device 301 is transmitted, for example, that the video is a recorded video, a recording channel, or a recording time are employed as the source information, so that those information can be displayed on the display 142 of the digital modulated wave reception device 302.

As described above, according to the transmission system, transmission device 301, and reception device 302 of the third embodiment, the transmission device 301 adds the source information which is information on the digital modulated wave to be transmitted to the digital modulated wave and transmits the source-information-added digital modulated wave, and the reception device 302 displays a channel or the like on the display 142 according to the source information when receiving the digital modulated wave to which the source information is added, whereby a channel (this time, 30ch) on which the video is actually broadcasted can be displayed on the display 142 despite the fact that transmission from the transmission device 301 to the reception device 302 is performed at difference frequency (this time, 48ch), in addition to the same effect as the effect of the first embodiment. Therefore, a user can view video and sound as if the digital modulated wave reception device 302 receives broadcast of the channel displayed on the display 142.

Further, even when the user looking at the display 142 operates the digital modulated wave transmission device 301 to change the reception channel, the source information is automatically modified, and thus the channel displayed on the display 142 can be also modified automatically.

As described above, the transmission system according to the third embodiment can be provided as a transmission system which enables a user to operate the same easily.

While in FIG. 3 the digital modulated wave transmission device 301 and the digital modulated wave reception device 302 are connected to the different electric lamp wire sockets, respectively, the both devices may be connected to the same electric lamp wire socket. Further, it is preferable that the electric lamp wire sockets to which the both devices are connected are adjacent electric lamp wire sockets in the same building such as a house and an office.

Further, while in the third embodiment the description has been given of the case where the source information is added to the digital modulated wave, the transmission device according to the present invention may superpose a control signal for the reception device on the digital modulated wave and transmit the control-signal-superposed digital modulated wave.

(Embodiment 4)

Hereinafter, a transmission system, a transmission device, and a reception device according to a fourth embodiment of the present invention will be described with reference to the drawing. The transmission system according to the fourth embodiment can extend a distance for which a digital modulated wave is transmitted.

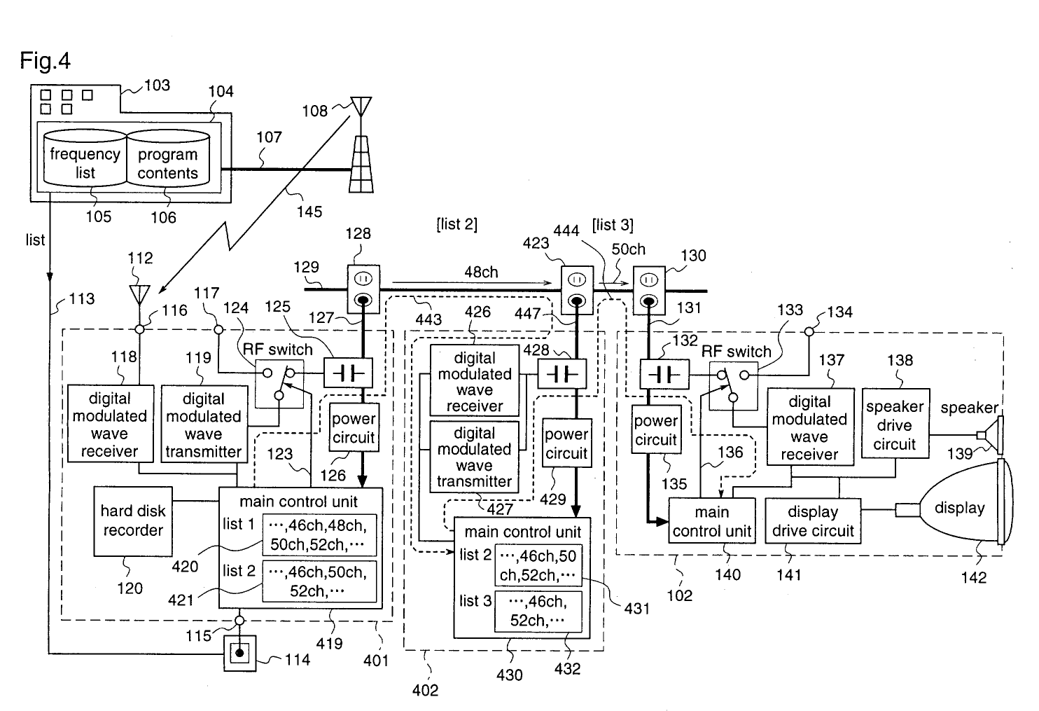

FIG. 4 is a block diagram illustrating the constitutions of a broadcasting station and the transmission system according to the fourth embodiment.

In FIG. 4, the transmission system according to the fourth embodiment comprises a digital modulated wave transmission device 401 which receives a frequency list and transmits a digital modulated wave employing frequency in the frequency list, a transmission device (hereinafter, referred to as a “repeater”) 402 which receives the frequency list transmitted from the digital modulated wave transmission device 401 and transmits the digital modulated wave employing frequency in the frequency list, and a digital modulated wave reception device 102 which receives the digital modulated wave transmitted from the repeater 402. Here, as the digital modulated wave transmission device 401, there is for example the above-described digital set top box. The same reference numerals as those shown in FIG. 1 denote the same parts of the broadcasting station and transmission system according to the first embodiment, and descriptions thereof will be omitted.

A main control unit 419 included in the digital modulated wave transmission device 401 has functions of creating a second frequency list 421 in which the frequency used for the transmission of the digital modulated wave by the digital modulated wave transmitter 119 is deleted from frequencies stored in a first frequency list 420 which is distributed from the broadcasting station 103, and adding the second frequency list 421 to a video/sound signal to output the second frequency-list added video/sound signal, in addition to the functions similar to those of the main control unit 121 according to the first embodiment.

The repeater 402 which is connected to an electric lamp wire socket 423 via a power line 447 comprises a digital modulated wave receiver 426, a digital modulated wave transmitter 427, a coupling capacitor 428, a power circuit 429, and a main control unit 430.

The digital modulated wave receiver 426, the digital modulated wave transmitter 427, the coupling capacitor 428, and the power circuit 429 are the same as the digital modulated wave receiver 118, the digital modulated wave transmitter 119, the coupling capacitors 125 and 132, and the power circuit 126 described in the first embodiment, respectively.

The main control unit 430 receives the video/sound signal and the frequency list from the digital modulated wave receiver 426 and stores the frequency list as the second frequency list 431. Further, the main control unit 430 creates a third frequency list in which frequency that is used for transmission of the digital modulated wave by the digital modulated wave transmitter 427 is deleted from frequencies in the second frequency list 431, and adds the third frequency list to the video/sound signal to output the third-frequency-list added video/sound signal.

Next, operations of the transmission system, transmission device, repeater, and reception device according to the fourth embodiment will be described. Except for the parts involving the main control unit 419 and the repeater 402, the operation of the transmission system is the same as that of the transmission system according to the first embodiment, and descriptions thereof will be omitted.

Here, assume that the digital modulated wave can be transmitted between the digital modulated wave transmission device 401 and the repeater 402 or between the repeater 402 and the digital modulated wave reception device 102, while the digital modulated wave cannot be transmitted between the digital modulated wave transmission device 401 and the digital modulated wave reception device 102 due to considerable signal attenuation.

The main control unit 419 stores the frequency list transmitted from the digital TV broadcasting station 103 as the first frequency list (hereinafter, referred to as a “list 1”) 420.

When the main control unit 419 selects 48ch from the list 1 as frequency at which the digital modulated wave is transmitted, the main control unit 419 creates the second frequency list (hereinafter, referred to as a “list 2”) 421 in which 48ch is deleted from the list 1. Then, the list 2 is added to a video/sound signal received from the digital modulated wave receiver 118 or a video/sound signal extracted from the hard disk recorder 120, and the list 2-added video/sound signal is outputted to the digital modulated wave transmitter 119.

Receiving the video/sound signal and the list 2 from the main control unit 419, the digital modulated wave transmitter 119 modulates the list 2-added video/sound signal into a digital modulated wave of 48ch specified by the main control unit 419, and outputs the digital modulated wave to the RF switch 124.

The path until the digital modulated wave is transmitted through the electric lamp wire 129 is the same as that described in the first embodiment.

The digital modulated wave transmitted through the electric lamp wire 129 is received by the digital modulated wave receiver 426 through the electric lamp wire socket 423, the power line 447, and the coupling capacitor 428.

The main control unit 430 of the repeater 402 makes the digital modulated wave receiver 426 execute channel search and detect the digital modulated wave transmitted from the digital modulated wave transmission device 401 to the repeater 402. Then, when the digital modulated wave receiver 426 detects the digital modulated wave of 48ch which has been transmitted from the digital modulated wave transmission device 401, the digital modulated wave receiver 426 demodulates the digital modulated wave, and outputs a video/sound signal and the list 2 added to the video/sound signal to the main control unit 430.

At the detection of the digital modulated wave, a prescribed code for discriminating the extraneous radio wave may be added to the digital modulated wave transmitted from the digital modulated wave transmission device 401 in order to discriminate between the digital modulated wave transmitted from the digital modulated wave transmission device 401 to the repeater 402 and an extraneous radio wave such as a disturbing radio wave by TV broadcasting. In that case, by detecting the code, the digital modulated wave receiver 426 can detect the digital modulated wave from the digital modulate wave transmission device 401.

The main control unit 430 receives the video/sound signal and the list 2, stores the list 2, and creates the third frequency list (hereinafter, referred to as a “list 3”) 432 in which 50ch employed for the transmission of the digital modulated wave by the digital modulated wave transmitter 427 is deleted from the list 2. Then, the main control unit 430 adds the list 3 to the video/sound signal received from the digital modulated wave receiver 426, and outputs the list 3-added video/sound signal to the digital modulated wave transmitter 427.

Receiving the video/sound signal and the list 3 from the main control unit 430, the digital modulated wave transmitter 427 modulates the list 3-added video/sound signal into a digital modulated wave of 50ch specified by the main control unit 430, and outputs the digital modulated wave to the coupling capacitor 428.

The operation until the modulated wave is transmitted through the electric lamp wire 129 and received by the digital modulated wave reception device 102, so that sound is outputted from the speaker 139, while video is projected on the display 142 is the same as that in the first embodiment.

Thus, the transmission path of the digital modulated wave according to the fourth embodiment is shown in dotted lines 443 and 444.

Since the digital modulated wave transmitted from the digital modulated wave transmission device 401 and the digital modulated wave transmitted from the repeated 402 are the same in formats and different only in the contents of the lists added thereto, when the digital modulated wave reception device 102 can receive the digital modulated wave from the digital modulated wave transmission device 401, the digital modulated wave reception device 102 may receive that digital modulated wave.

While in the fourth embodiment the description has been given of the case where one repeater 402 is provided, the number of the repeater is not restricted to one, and two or more repeaters may be also employed. When a distance between the transmission device 401 and the reception device 102 is larger, it is effective to employ two or more repeaters.

As described above, according to the transmission system, transmission device 401, reception device 102, and repeater 402 of the fourth embodiment, the repeater 402 is employed, so that even when the distance between the transmission device 401 and the reception device 102 is not within the direct reach of the digital modulated wave, the digital modulated wave from the transmission device 401 can be received by the repeater 402 and further transmitted as a digital modulated wave of different frequency, thereby realizing a transmission system which enables extension of the transmission distance, in addition to the same effect as the effect of the first embodiment.

While, in the transmission system according to the fourth embodiment, the electric lamp wire socket to which the digital modulated wave transmission device 401 is connected and the electric lamp wire socket to which the digital modulated wave reception device 102 is connected may be distant from each other, it is favorable that the electric lamp wire socket to which the digital modulated wave transmission device 401 is connected and the electric lamp wire socket to which the repeater 402 is connected are adjacent in the same building such as a house and an office, and further it is favorable that the electric lamp wire socket to which the repeater 402 is connected and the electric lamp wire socket to which the digital modulated wave reception device 102 is connected are also adjacent similarly.

APPLICABILITY IN INDUSTRY

As described above, a transmission system according to the present invention transmits a digital modulated wave through an electric lamp wire or through the air via radio waves, and is suited as a transmission system which is constituted by a digital set top box such as a digital video camcorder and a hard disk recorder, and a digital TV.

1. A transmission system comprising:
a transmission device for receiving a list of frequencies that are judged to be unlikely to cause mutually detrimental disturbance between themselves and the other users who are allowed to use a TV broadcast frequency spectrum by a public institution, and transmitting a digital modulated wave using frequency in the frequency list; and
a reception device for receiving the digital modulated wave transmitted from the transmission device.

2. The transmission system as defined in claim 1, wherein
the transmission device does not transmit the digital modulated wave when the frequency list is not updated within a previously defined period.

3. The transmission system as defined in claim 1, wherein
the transmission device transmits the digital modulated wave through an electric lamp wire, and
the reception device receives the digital modulated wave transmitted through the electric lamp wire.

4. The transmission system as defined in claim 1, wherein
the transmission device transmits the digital modulated wave through the air via radio waves, and
the reception device receives the digital modulated wave transmitted through the air.

5. The transmission system as defined in claim 1, wherein
the transmission device transmits the digital modulated wave with source information as information on the digital modulated wave added thereto, and
the reception device includes a display for projecting video, receives the digital modulated wave to which the source information is added, and projects video on the display on the basis of the source information.

6. The transmission system as defined in claim 1 including
a plurality of the reception devices.

7. The transmission system as defined in claim 1 further including
a repeater for receiving the digital modulated wave transmitted from the transmission device and transmitting the digital modulated wave at frequency included in the frequency list, which is different from the frequency of the received digital modulated wave, wherein
the reception device receives the digital modulated wave from the repeater, instead of the digital modulated wave from the transmission device.

8. The transmission system as defined in claim 7 including
a plurality of the repeaters.

9. The transmission system as defined in claim 1, wherein
the transmission device and the reception device perform transmission and reception of the digital modulated wave in the same building.

10. A transmission device for receiving a list of frequencies that are judged to be unlikely to cause mutually detrimental disturbance between themselves and the other users who are allowed to use a TV broadcast frequency spectrum by a public institution, and transmitting a digital modulated wave using frequency in the frequency list.

11. The transmission device as defined in claim 10 comprising:
a reception means for receiving a digital modulated wave from a broadcasting station and demodulating the digital modulated wave into a video/sound signal;
a transmission means for modulating the video/sound signal into a digital modulated wave and transmitting the digital modulated wave; and
a control means for outputting the video/sound signal from the reception means to the transmission means and controlling the transmission means so that it transmits the video/sound signal at the frequency in the frequency list.

12. The transmission device as defined in claim 10, wherein
the digital modulated wave is not transmitted when the frequency list is not updated within a previously defined period.

13. The transmission device as defined in claim 10, wherein
the digital modulated wave is transmitted through an electric lamp wire.

14. The transmission device as defined in claim 10, wherein
the digital modulated wave is transmitted through the air via radio waves.

15. The transmission device as defined in claim 10, wherein
the digital modulated wave is transmitted with source information as information on the digital modulated wave added thereto.

16. The transmission device as defined in claim 10, wherein
a second frequency list in which the frequency employed for the transmission of the digital modulated wave is deleted from the frequency list is created, and the digital modulated wave is transmitted with the second frequency list added thereto.

17. The transmission device as defined in claim 10, wherein
the digital modulated wave is transmitted to devices in the same building.

18. A reception device for receiving a digital modulated wave transmitted at frequency that is judged to be unlikely to cause mutually detrimental disturbance between itself and the other users who are allowed to use a TV broadcast frequency spectrum by a public institution.

19. The reception device as defined in claim 18, wherein
a digital modulated wave transmitted through an electric lamp wire is received.

20. The reception device as defined in claim 18, wherein
a digital modulated wave transmitted through the air via radio waves is received.

21. A reception device comprising:
a reception means for receiving a digital modulated wave to which source information as information on the digital modulated wave is added and demodulating the digital modulated wave into a video/sound signal and the source information;
a speaker for outputting sound;
a display for projecting video; and
a control means for receiving the video/sound signal and the source information from the reception means, and outputting the sound signal to the speaker, while outputting a signal indicating video on the basis of the source information and the video signal from the reception means to the display.

22. A repeater for receiving a digital modulated wave to which a frequency list is added, creating a second frequency list in which frequency used for transmission of the digital modulated wave is deleted from the frequency list, and transmitting the digital modulated wave with the second frequency list added thereto.

23. A frequency list sending device for sending a list of frequencies that are judged to be unlikely to cause mutually detrimental disturbance between themselves and the other users who are allowed to use a TV broadcast frequency spectrum by a public institution.

24. A transmission reception system comprising:
a frequency list sending device for sending a list of frequencies that are judged to be unlikely to cause mutually detrimental disturbance between themselves and the other users who are allowed to use a TV broadcast frequency spectrum by a public institution;
a transmission device for receiving the frequency list and transmitting a digital modulated wave using frequency in the frequency list; and
a reception device for receiving the digital modulated wave transmitted from the transmission device, wherein
the transmission device does not transmit the digital modulated wave when the frequency list is not updated within a previously determined period.
